(19) United States
(12) Patent Application Publication
(10) Pub. No.: US 2024/0303665 A1
(43) Pub. Date: Sep. 12, 2024

(54) SYSTEMS AND METHODS FOR DISTRIBUTED BLOCKCHAIN MONITORING AND INHERENT LATENCY COMPENSATION

(71) Applicant: Dennis R. Gesker, Three Forks, MT (US)

(72) Inventor: Dennis R. Gesker, Three Forks, MT (US)

(21) Appl. No.: 18/323,408

(22) Filed: May 25, 2023

Related U.S. Application Data
(60) Provisional application No. 63/450,643, filed on Mar. 7, 2023.

(51) Int. Cl. G06Q 20/40; G06Q 20/38

(52) U.S. Cl. CPC G06Q 20/4037; G06Q 20/389

(57) ABSTRACT

Methods, systems and computer readable media for managing (e.g., queuing, batching, submission, and logging) and monitoring distributed blockchain operations such as cryptocurrency operations and transactions by client application systems and end users of a client application system to compensate for the inherent latency in distributed blockchain systems.

### RELATED APPLICATIONS

This application claims the benefit of U.S. Provisional Application No. 63/450,643, entitled “Systems and Methods for Distributed Blockchain Monitoring and Inherent Latency Compensation” and filed on Mar. 7, 2023, which is incorporated herein by reference in its entirety.

### TECHNICAL FIELD

Implementations relate generally to blockchain transaction systems. More particularly, implementations relate to systems and methods of monitoring distributed blockchain transaction systems, such as cryptocurrency networks, enabling applications, and by extension end users, to queue, batch, submit, log and monitor blockchain operations and transactions to compensate for inherent latency.

### BACKGROUND

A distributed blockchain network is a technical infrastructure including a plurality of nodes whereby applications access a ledger and related smart contract services. The infrastructure is generally used to originate transactions which are then transmitted to each peer node in the network and recorded in an immutable fashion on each node's copy of the ledger. Anything of value may be recorded and traded using the infrastructure, such as orders, accounts, payments, production records. Blockchain networks can be public or private. A popular use of blockchain networks includes the exchange of cryptocurrency.

As of the writing of this application, a well-known application of blockchain technology is the Bitcoin Cryptocurrency Network. Most, if not all, blockchain networks derive in some fashion their architecture from the Bitcoin project and thus benefit from its technological advances as well as its limitations, including latency.

Privacy coin blockchain networks such ZCash, Monero, etc. may derive their architectures from the Bitcoin network but provide a security capability not yet found in the Bitcoin network. However, these security capabilities create a special challenge for firms and regulators as these networks encrypt and obfuscate transactions written to their blockchain records that are generally only visible to the payer and payee in the transaction. This differs of course from Bitcoin where all transactions are public, which enables organizations to benefit from the security in these networks while still being able to comply with regulations imposed by authorities over their respective jurisdictions be they organizational or legal entities.

Efforts are underway to improve the overall speed of blockchain networks and cryptocurrency blockchain networks specifically. Such efforts include the Lightning Network project for example. However, the Lightning Network and similar efforts continue to use ledger style data storage, smart contracts and other related blockchain technologies not necessarily utilized by disclosed subject matter. Further, the efforts of similar projects to increase the performance of blockchain networks themselves while the disclosed subject matter was incepted, with the aim of improving the performance of client applications within their native information system when iterating with blockchain nodes and blockchain networks that carry data between information systems. The goals of the disclosed subject matter and projects like the Lightning network are the same-better blockchain network performance-but the approaches are different.

Message queues have been in use in information systems for many years. Some message queues are general purpose and strictly separate the concerns of systems sending data to the queue from the systems pulling data from the queue or systems that receive data from the queue via a subscription model. This breaks that separation of concern model as the system will queue data from a client application but also reaches into the system for which the queued data is intended to monitor, log, optimize based on orderly transmission via a desired individual transmission model, e.g., first in first out (FIFO) or an orderly transmission via a collecting and batching approach that uses the blockchain node efficiently while very likely enjoying reduced blockchain network fees. Both approaches can be combined—in the case where the system is aware of a blockchain wallet managed by the blockchain node and can index end users to cryptocurrency accounts/addresses to reduce if not entirely eliminates “double spend” lockups that reduce blockchain node performance related to attempting multiple spend activities from the same cryptocurrency account/address. In these respects, this system is in no way generic as is message queuing with regard to generalized information system queueing needs but is specific to benefiting client applications utilizing blockchain nodes and blockchain networks. Further, message queuing has a separation of concerns between data producers and data consumers and in that respect the disclosed system does not observe a separation of concern between the client application and the blockchain node. In fact, the system could be described with regard to information system concerns as not separate but intrusive.

Some implementations were conceived in light of the above-mentioned needs, problems and/or limitations, among other things.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

Some implementations can support client application interaction with blockchain networks.

Some implementations can include an integrated set of components for collecting, storing, processing data with a design goal of promoting positive end user interaction through the economic process of price discovery utilizing cryptocurrency micro-transactions as described in co-pending U.S. Patent Application entitled “Systems and Methods for Economic Price Discovery in Social Media Networks Including Games,” by the same inventor as the present application and filed on an even date herewith, which is incorporated herein by reference in its entirety. The integrated set of components can be used as part of a game or a social media information system, among other things.

An advantage of one or more implementations of the disclosed subject matter is an ability to provide reliable, durable, high throughput, high volume, low latency operation and transaction interaction with a blockchain node in order to support computer applications including games, social interaction and financial transactions.

Some implementations can include a system comprising a computer program accompanied by data storage. The system can be connected between a client application and a blockchain node in order to manage and monitor transactions that the application requires the blockchain network to process.

In some implementations, the methods of the system can either be embedded directly into an application, utilized as a code library, or incorporated into a service for use by multiple client applications across a computer network.

In some implementations, the system can benefit the client application by queuing, batching, submitting and logging transaction data, operation state changes and transactions state changes that would otherwise have been sent directly to the blockchain node of the blockchain network of interest to the information system of which the client application is a component.

In some implementations, the system can benefit the client application by permitting the client application to off load the processing tasks associated with the blockchain transaction to a system enabling the client application to continue processing its instructions without the burden of the latency inherent to a distributed blockchain network.

In some implementations, the system benefits the client application by providing an API so that at any time the client application can know the state of the blockchain operation and blockchain transaction without having to directly query the blockchain node.

In some implementations, the system benefits the client application by providing durability to the clients blockchain transaction needs in that by accepting the clients blockchain into the systems datastore the system can hold the blockchain transaction directive in queue until the intended blockchain node the system was configured to communicate with recovers from an outage or communications error thus ensuring the client application no blockchain data will be lost.

In some implementations, the system benefits the client application, in the case where the system is configured to communicate with a blockchain node whose blockchain network includes the purpose of processing cryptocurrency transactions, in that the system maintains a calculated available balance which is the last report known correct balance associated with the client application's associated process or end users less any pending and in process transactions managed and monitored by the system on behalf of that associated process or end user.

In some implementations, the system benefits the client application, in the case where the system is configured to communicate with a blockchain node whose blockchain network includes the purpose of processing cryptocurrency transactions, in that the system returns to client application an appropriate code indicating that the intended blockchain transaction will fail if it were actually submitted to the blockchain node as the system maintains a correct available balance as indicated above.

In some implementations, the system benefits the client application by facilitating high volumes of blockchain transactions by queuing transactions to be processed by the blockchain node and relaying these transactions to the blockchain node in a metered and orderly fashion.

In some implementations, the system benefits the client application by facilitating efficient processing of blockchain transactions by queuing transactions to be processed by the blockchain node, assembling multiple queued transactions into a batch of transactions and relaying these batches of transactions to the blockchain node as a single bulk transaction.

In some implementations, the system benefits the client application by affording cost savings using the approach indicated above in that the cost structure of most blockchain networks tend to assess a lower processing cost to single bulk transactions with a given number of transactions where there is a single payer and many payees over given number of many individual transactions where there is a single payer and single payee. This benefit is related to blockchain networks that process cryptocurrency transactions.

In some implementations, the system benefits the client application by providing methods which allow the client application developers and operators to tune the frequency of monitoring status checks against the blockchain node to ensure desired performance metrics of the application and predetermine the load placed on the blockchain node by the system on behalf of the client application.

The system benefits the client application by returning to the application low latency responses to the directive issued to it by the client application that is in line with the needs of high speed financial transactions, gaming, social media and other modern software applications as the system has immediate methods for interacting with the application client while at the same time optimizing what data is sent to the blockchain node for processing while maintaining a complete record of the state of operation state and transaction state within the blockchain node.

Data coming into the system from the client application does not suffer an inherent latency penalty and the data leaving the system is optimized and metered to the high latency blockchain node and blockchain network processes.

The system benefits the client application under the circumstance that blockchain node and blockchain node required to complete blockchain distributed database write operations and transactions may have been designed to provide transactional privacy by encrypting and obfuscating the transaction. As the implementation maintains detailed records of received data and the operation state and transaction state of the data as it completes the blockchain consensus and blockchain data write operations these records would allow the organization utilizing the system and its methods to maintain auditing records of transaction data sent to the blockchain network via the blockchain node. These records would serve the operators of the client application in efforts to adhere to their compliance obligations. These records are of particular use to client applications that engage in spend transactions on behalf of end users or associated processes where the system is configured to communicate with a blockchain node that participates not only in cryptocurrency transactions by privacy coin cryptocurrency transactions.

In some implementations, the system provides the benefit of flexibility to the client application as although the systems methods require a data store the system is not necessarily limited by the nature of the data store be it an in-computer memory data structure, flat file storage, relational database management system, or document database system. The storage approach can be selected to suit the needs of the client application i.e., with regard to performance characteristics or the operators of the client application i.e., with regard to reporting needs.

Where necessary or beneficial, as may be the case with cryptocurrency transactions performed on behalf of end users and or associated constituent subsystems, the system can also maintain records of association or index of accounts to cryptocurrency accounts/addresses stored in the wallet file associated with and/or controlled by the blockchain node and network. A wallet can contain keys to allow spend transactions and typically a summary of relevant transactions for the keys in the blockchain. With the keys the summary information in the wallet can be rebuilt by scanning the blockchain. Most nodes store the wallet as a “dat” file—Berkeley db and Sqlite are popular ways to manage the wallet.dat file—but this information (keys, summary, history, etc.) can be kept in any data store. This benefits the client application by allowing the system to further optimize how transactions are metered to the blockchain node in that the system can disallow a multiple cryptocurrency spend accounts/addresses to be submitted or allowed to be in process within a blockchain node at the same time reducing the potential of a “double spend” conflict and subsequent blockchain node mitigation thus ensuring efficient processing.

Some implementations can include a method. The method can include receiving a transaction for a blockchain, writing the transaction to a data store, packaging and formatting the transaction according to a given blockchain network, and verifying that the transaction is structured as required by the given blockchain network.

The method can also include submitting a transaction operation to the blockchain node using the API provided by the blockchain network node, monitoring progression of the transaction to completion, storing progression of the transaction, and determining success or failure of the transaction.

In some implementations, when a blockchain node required to complete the transaction is unavailable, accepting into a queue the transaction ultimately intended for the blockchain node until the blockchain node returns to service ensuring no transactional activity sent by the client application is lost. In some implementations, a blockchain node required to complete a procedure initiated by the application is for the processing of cryptocurrency a spend transaction submitted to the API will fast fail and return an appropriate code to the calling client application.

In some implementations, when the application user has insufficient funds associated with their cryptocurrency account/address or the API determines that the balance associated with the cryptocurrency account/address less any pending and in process transactions managed and monitored is insufficient to complete the transaction, an indication of insufficient funds is returned.

The method can further include maintaining a correct available balance is returned regardless of the processing state of the operation and transaction in the blockchain network or operational condition of the blockchain node. In some implementations, the blockchain node required to complete the procedure intended by the application is for the processing of cryptocurrency once any pending and in process transactions monitored by the system are completed, the available balance reported is equal to the actual balance of the blockchain account/address.

The method can also include querying the blockchain node as desired by the application or on a regularly configured schedule and updating the recorded progress of the submitted transaction in its associated data store. The method can further include when several or many transactions are submitted, attempting to combine the individual transactions into a single transaction where the blockchain node supports a send many transaction or write many transaction.

Some implementations can include a system. The system can include a processor coupled to a nontransitory computer readable medium having stored thereon software instructions that, when executed by the processor, cause the processor to perform operations. The operations can include receiving a transaction for a blockchain, writing the transaction to a data store, packaging and formatting the transaction according to a given blockchain network, and verifying that the transaction is structured as required by the given blockchain network.

The operations can also include submitting a transaction operation to the blockchain node using the API provided by the blockchain network node, monitoring progression of the transaction to completion, storing progression of the transaction, and determining success or failure of the transaction.

In some implementations, when a blockchain node required to complete the transaction is unavailable, accepting into a queue the transaction ultimately intended for the blockchain node until the blockchain node returns to service ensuring no transactional activity sent by the client application is lost.

In some implementations, a blockchain node required to complete a procedure initiated by the application is for the processing of cryptocurrency a spend transaction submitted to the API will fast fail and return an appropriate code to the calling client application. In some implementations, when the application user has insufficient funds associated with their cryptocurrency account/address or the API determines that the balance associated with the cryptocurrency account/address less any pending and in process transactions managed and monitored is insufficient to complete the transaction, an indication of insufficient funds is returned.

In some implementations, the instructions further include maintaining a correct available balance is returned regardless of the processing state of the operation and transaction in the blockchain network or operational condition of the blockchain node.

In some implementations, the blockchain node required to complete the procedure intended by the application is for the processing of cryptocurrency once any pending and in process transactions monitored by the system are completed, the available balance reported is equal to the actual balance of the blockchain account/address.

The operations can further include querying the blockchain node as desired by the application or on a regularly configured schedule and updating the recorded progress of the submitted transaction in its associated data store. The operations can further include when several or many transactions are submitted, attempting to combine the individual transactions into a single transaction where the blockchain node supports a send many transaction or a write many transaction.

Some implementations can include a non-transitory computer readable medium having stored thereon software instructions that, when executed by a processor, cause the processor to perform operations. The operations can include receiving a transaction for a blockchain, writing the transaction to a data store, packaging and formatting the transaction according to a given blockchain network, and verifying that the transaction is structured as required by the given blockchain network. The operations can also include submitting a transaction operation to the blockchain node using the API provided by the blockchain network node, monitoring progression of the transaction to completion, storing progression of the transaction, and determining success or failure of the transaction.

In some implementations, when a blockchain node required to complete the transaction is unavailable, accepting into a queue the transaction ultimately intended for the blockchain node until the blockchain node returns to service ensuring no transactional activity sent by the client application is lost. In some implementations, a blockchain node required to complete a procedure initiated by the application is for the processing of cryptocurrency a spend transaction submitted to the API will fast fail and return an appropriate code to the calling client application. In some implementations, when the application user has insufficient funds associated with their cryptocurrency account/address or the API determines that the balance associated with the cryptocurrency account/address less any pending and in process transactions managed and monitored is insufficient to complete the transaction, an indication of insufficient funds is returned.

### BRIEF DESCRIPTION OF THE DRAWINGS

FIG. 1A is a block diagram of an example network environment configured for monitoring distributed blockchain transaction systems in accordance with some implementations.

FIG. 1B is a diagram of a conventional standard architecture including a client application/blockchain interaction.

FIG. 2 is a diagram of an example enhanced architecture including an application, an implementation of the disclosed subject matter, and an example blockchain interaction in accordance with some implementations.

FIG. 3 is a flowchart showing an example logical operation flow for blockchain network in accordance with some implementations.

FIG. 4 is a flowchart showing an example logical transaction flow for blockchain network in accordance with some implementations.

FIG. 5 is an example SQL Diagram of Data Store in accordance with some implementations.

FIG. 6 is a diagram of an example computing device configured to monitor distributed blockchain transaction systems in accordance with at least one implementation.

### DETAILED DESCRIPTION

In some implementations, the system and method are made usable to a computer application via an application programming interface (API) supported by a data store, e.g., a relational database management system (RDBMS) as it is implemented in the prototype, a flat file database, or state values simply held in memory.

The system and method can provide the flexibility of utilizing the system and method embedded directly in the application or wrapping an implementation into an independent or external subsystem for decoupled processing from the main application, e.g., implemented by the developer as a service or micro-service.

During the process of developing a social media information system, the present inventor noted that the latency inherent in completing a cryptocurrency operations and transactions upon a distributed blockchain node and its subsequent network was relatively high. Blockchain operations and transactions could have a duration ranging from minutes to longer than an hour.

The duration required for the completion of blockchain operations and transactions would be typically unacceptable in meeting the responsiveness requirements of a typical modern computer application. Both user interface responsiveness and dependent application activities in modern applications typically require application programming interfaces (APIs) call durations measured in milliseconds.

An example application use case of the disclosed subject matter calls for a very high volume and frequency of cryptocurrency transactions to be written into the distributed blockchain database. The blockchain operations and transactions would not be under the control of the developer but as long it could be determined with certainty the operations and transactions would eventually (at a future time) be written to the distributed blockchain database a system and method could be devised to track and manage the state and progress of required blockchain node and network interactions.

In order to be acceptable to users, a system and method may need to be highly responsive to the calling client application. In order to meet the needs of the application under development, a system and method may provide for large volumes of transactions to be reliably processed by an application and related subsystems against the blockchain node software that ultimately interacts i.e., reads and writes data to the distributed blockchain database while also providing near real time responsiveness to the client application providing. The system and method should be able to provide the client application with correct future states (including cryptocurrency available balances) and status of operations and transactions.

It may be desirable for a solution to function appropriately in a constrained computing environment i.e., mobile and edge computing devices. The solutions may need to also lend itself to implementation and incorporation as a monolithic service or containerized microservice in a less resource constrained environments typically used to support web applications, financial trading applications, gaming applications and the like that demand reliable, durable, high throughput and frequency, high volume and fast response times from systems upon which they depend.

In some implementations, the solution may also need to satisfy a requirement that a client system and/or end user would not be able to spend more than the balance associated with their cryptocurrency address where the system was specifically interacting with a blockchain node established for the purpose of sending/receiving cryptocurrency.

In some implementations, the solution required may keep an accurate account of the end user's balance within the blockchain where the system was specifically interacting with a blockchain node that has the purpose of sending/receiving cryptocurrency regardless of the double spend controls built into the blockchain network. Under certain conditions blockchain nodes supporting cryptocurrency networks could return an incorrect or zero balance particularly where the blockchain network was not designed for high frequency.

In some implementations, the solution may need to account for high volumes of transactions to support financial transactions, games, social interactions and related application activities that require blockchain transactions and sub millisecond latency regardless of the individual transaction size and/or amount.

In some implementations, the solution may provide full blockchain transaction monitoring and reporting from operation initiation to transaction completion whether the completed state resulted in a success or failure.

In some implementations, the solution may provide durability by monitoring for failed operations and transactions on the blockchain by retrying that transaction until it is successful, or a preconfigured (re)attempt count or time threshold was reached.

In some implementations, the solution may provide durability by tolerating outages or responsiveness delays and failures in the blockchain node or network.

In some implementations, the solution would typically need to return a correct “available balance” for the account/address even under circumstances where the blockchain node for a given blockchain network might return an incorrect or zero balance i.e., circumstances where a user has funds but the unspent transaction output (UTXO) is not credited towards the account/address balance returned by the blockchain node API attempting to mitigate or prevent an attempted “double spend” transaction being written into the blockchain.

Some implementations can include a collection of computer instructions which could be included in an application directly, included as a library or incorporated into service reachable by one or more applications over a computer network.

Some implementations can include an ability to batch transactions under its control to the blockchain node reduces the load on the blockchain node, and where transaction fees are assessed by the blockchain network, this consolidation activity affords opportunities for the application and its end users to enjoy cost savings. A single transaction from one payer to many payees may be cheaper on a cryptocurrency blockchain network than many individual transactions from payer to payee. Some implementations can permit the application developer to tune the frequency of monitoring status checks against the blockchain node to ensure desired performance metrics of the application and predetermine the load placed on the blockchain node by the application and the implementation. In some implementations, the software can be tuned to take advantage of blockchain volume cost, hash rate arbitrage and generally determine the load placed on the network node associated with the system. In some implementations, when transactions are queued into the system a parameter indicates how “aggressive” to be in sending the transactions on to the actual blockchain node. For instance, if the user of the application is heavy (e.g., X spend transactions every second) it may be better to group the transactions and send them as one. But, if the user is light (e.g., typically 1 spend transaction a day or the like) the system can send the data to the blockchain network and be expedited with regard to the queueing step of the process. This parameter can be tuned for a desired flux.

Also, crypto nodes typically have a “confirmation” setting or the like. For example, “I believe you have $5 dollars if 100 servers confirm you have $5 dollars” and blockchain balance==5 if 100 servers agree. However, if only 99 agree the node returns a balance==$0. On Bitcoin this setting is called “miniconf” and can be overridden by an API call for the balance. The pseudo code for such a function call could be: getBalance (account, numberOfServersThatAgree).

So, even if the node is set to 100, most blockchain networks will allow one to ask: “give me the balance where 500 servers agree.” In some implementations of the disclosed system, if the “TO” and “FROM” accounts are BOTH accounts/addresses that are managed by the application-for example one can set the miniconf==1.

An example usage scenario includes after hours trading. For example:
The NYSE is closed.
User A trades stock at Brokerage.
User B also trades stock at Brokerage.
User A want to buy 100 Nvidia@$235.
User B is willing to sell 100 NVIDIA@$235.

Brokerage will make the transaction happen and both user's accounts will reflect the transaction but, in actuality, the trade will ultimately have to settle at the NYSE before open the next morning. If one asked NYSE how much NVIDIA was in User A's account NYSE would report 0 NVidia. If one asked the Brokerage, the Brokerage would report 100 NVidia.

The brokerage knows all the accounts on their system so they can facilitate this transaction. The disclosed system is represented by the Brokerage in this example scenario when both accounts are in the system and the transactions can be “folded” into the Brokerage's own trade book that will ultimately settle on NYSE.

And, if for some reason, there are times of day when blockchain transactions are low the fees will also be low so the system can take advantage of that as well. This feature correlates to the “Hash Rate” of a blockchain network. In some implementations, a user could configure the disclosed system to take advantage of this arbitrage for cost and/or profit optimization, where rules or regulations permit.

Some implementations can include a “balance drift” parameter. A “working/available” balance can be no more than $X different from the actual blockchain balance for an account. For example, if the blockchain balance==$600 and system balance==$50, the system may throw a warning and let the blockchain catch up before processing anymore transactions on this account.

It will be appreciated that the above narrative examples are provided for illustration purposes and exact details may differ based on a specific implementation. For example, blockchain networks may have their own currency symbols and may not utilize the US dollar sign or the like.

And, more generally, If the CPU/Memory being used by the blockchain node is high, reduce the rate of transactions forwarded to the blockchain node until the RAM, CPU, and/or I/O utilization of the blockchain node are reduced to desired operating parameters.

Some implementations can provide to the application sub millisecond responsiveness that is in line with the needs of high-speed financial transactions, gaming, social media and modern software applications.

In some implementations, a blockchain node may be required to complete blockchain distributed database write operations and transactions required by the client application and may be intended for the processing of cryptocurrency and the cryptocurrency network is designed for transactional privacy by encrypting and obfuscating the transaction an implementation would allow the organization utilizing an implementation to maintain fiscal auditing records of cryptocurrency spend transactions for organizational compliance obligations.

In some situations, client application operational requirements may require that the system maintain an index of accounts to cryptocurrency accounts/addresses stored in the wallet file controlled by the blockchain node affording the opportunity of consolidation and security of these account records by the system administrator of the system.

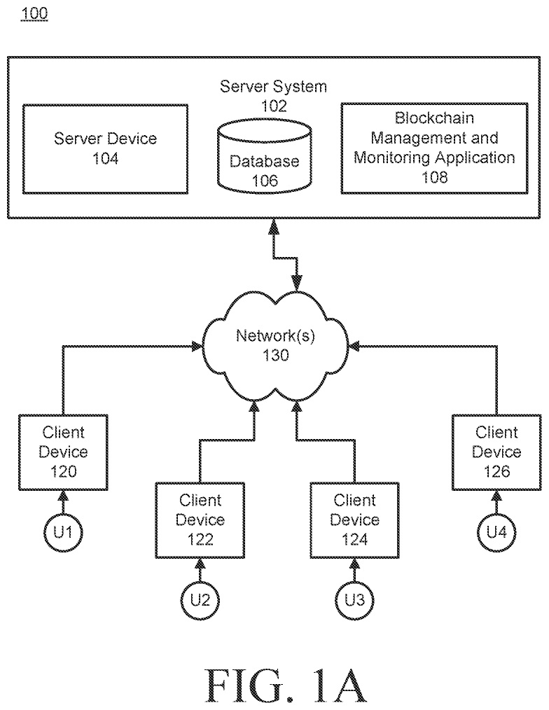

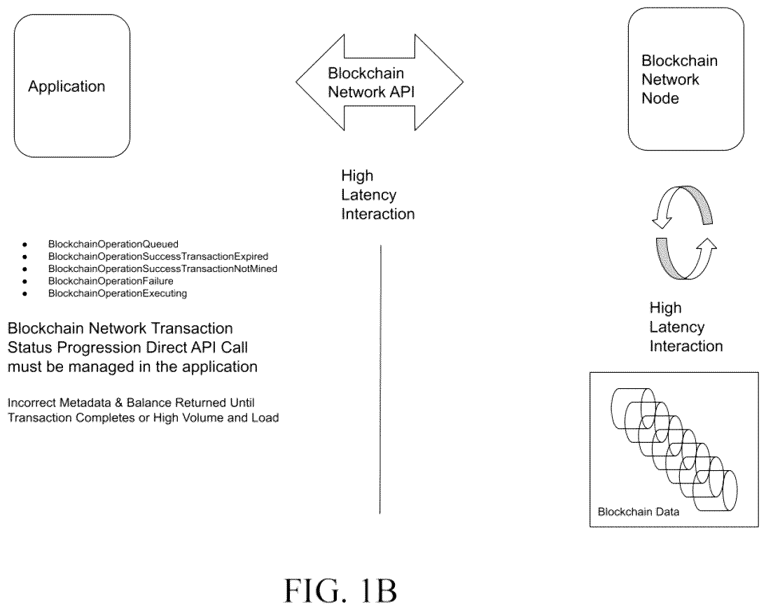

FIG. 1A illustrates a block diagram of an example network environment 100, which may be used in some implementations described herein. In some implementations, network environment 100 includes one or more server systems, e.g., server system 102 in the example of FIG. 1A. Server system 102 can communicate with a network 130, for example. Server system 102 can include a server device 104, a database 106 or other data store or data storage device, and an application for monitoring distributed blockchain transaction systems 108 as described herein. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1A shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide functions for monitoring distributed blockchain transaction systems.

Various implementations of features described herein can use any type of system and/or service. Any type of electronic device can make use of features described herein. Some implementations can provide one or more features described herein on client or server devices disconnected from or intermittently connected to computer networks.

FIG. 1B is a diagram of a conventional standard architecture including a client application/blockchain interaction without the improvement of an implementation of the disclosed subject matter.

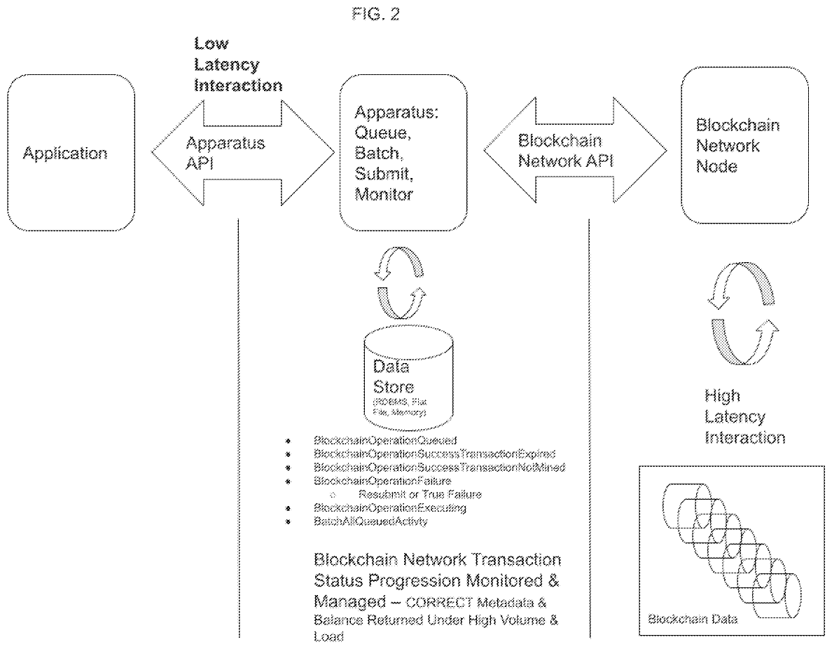

FIG. 2 is a diagram of an example enhanced architecture including an application, an implementation of the disclosed subject matter, and an example blockchain interaction in accordance with some implementations.

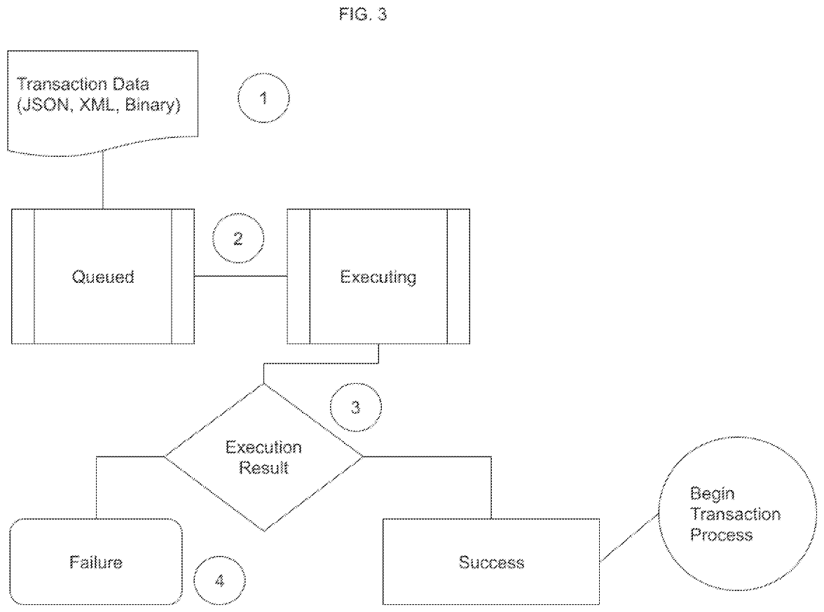

FIG. 3 is a flowchart showing an example logical operation flow for blockchain network in accordance with some implementations. Processing begins at step 1 where a properly formatted and structured transaction data is sent to the blockchain node on behalf of the client application so that the blockchain node may begin initial operations. Processing continues to 2.

At step 2, the state progression from Operation Queued Status to Operation Executing Status is monitored and logged. Processing continues to 3.

At step 3, the Operation Execution is monitored and logged. Processing continues to 4.

At step 4, the Operation Execution Result and a failure code to the client application monitoring and logging if necessary. Some implementations can be configured to resubmit the Transaction Data to the Operation Queue based on the needs of the client application after a transaction activity has been transitioned from Operation Execution Result to Operation Failure.

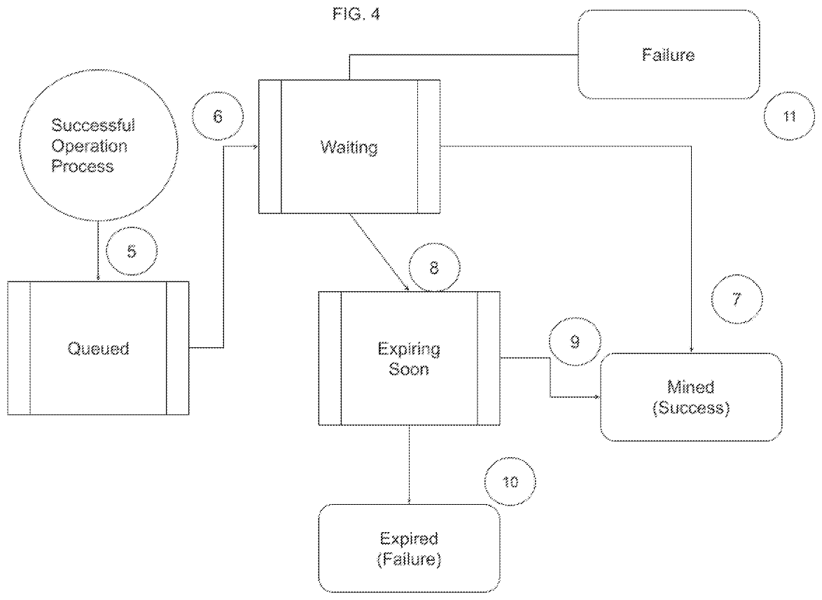

FIG. 4 is a flowchart showing an example logical transaction flow for blockchain network in accordance with some implementations. Logical Transaction Flow for Blockchain Network that begins only if the Blockchain Node Operation process is successful.

At step 5, the systems monitors and logs the transition from Operation Success to Transaction Queued.

At step 6, the system monitors and logs the transition from Transaction Queued to Transaction Waiting. Note that the state names of a typical blockchain transaction flow (e.g., Waiting, Expiring Soon and Expired) imply the latency inherent in Blockchain Networks that the system mitigates at state transition steps 6, 8 and 10.

At step 7, the system monitors and logs the transition of the transaction state progression from Transaction Waiting to Transaction Mined (Success). The state progression from Transaction Waiting to Transaction Mined (Success) is a high latency step. At step 7, the node is communicating with other nodes on the blockchain network of which it is a part where the consensus process which is often based on immutable consensus rules meaning that this operation cannot be optimized by a programmer developing the client application, the speed at which the computer network upon which the blockchain network nodes communicate, and the speed of the computers upon which the blockchain network nodes run in order to confirm that a blockchain network consensus has been reached so that data may be appended to the blockchain determines the duration of time that a client application not using an implementation of the disclosed subject matter will have to wait to complete the execution of the code routine that is communicating with the blockchain node for the purposes of including data in the blockchain database.

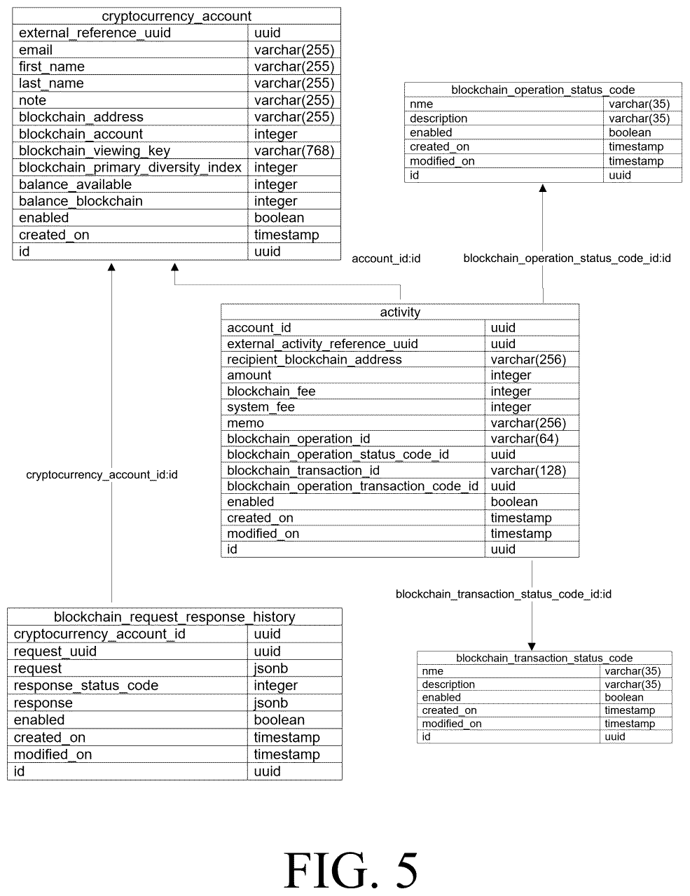

Also, as shown in FIG. 5, depending on the time parameters of the blockchain network the transaction state of Transaction Waiting may be transitioned to Transaction Expiring Soon as shown at step 8. The state transition at step 8 is monitored and logged.

At step 9, the system monitors and logs the progression from Transaction Expiring Soon to Transaction Mined (Success).

Depending on the time parameters of the blockchain network the transaction state of Transaction Expiring Soon may be transitioned to Transaction Expired (Failure) as shown at step 10. Some implementations can be configured to resubmit the Transaction Data to the Operation Queue based on the needs of the client application after a transaction activity has been transitioned from Transaction Expiring Soon to Transaction Expired (Failure). The state transition from Transaction Expiring Soon to Transaction Expired (Failure) at step 10 is monitored and logged by the system.

Upon a general blockchain node or blockchain network failure the transaction state may be transitioned from Transaction Waiting to Transaction Failure as noted at step 11. Some implementations can be configured to resubmit the Transaction Data to the Operation Queue based on the needs of the client application after a transaction activity has been transitioned from Transaction Waiting to Transaction Failure. The state transition from Transaction Waiting to Transaction Failure at step 11 is monitored and logged.

FIG. 5 is an example SQL Diagram of Data Store in accordance with some implementations. FIG. 5 shows an SQL Diagram of example data tables of the system when configured to log and record data to a Relational Database Management System. This model can be adapted to support the system as memory data structure, document databases and flat file data store. Tables in the diagram are supported by audit and history facilities that allow the operator of the system to see every how the data store changed over time.

An evaluation and test system was implemented using the Java programming language used in a mobile application, as a microservice using the Quarkus framework as part of a larger and more complex information system, and as a Java EE application where it is configured to process queued transactions based on time schedules.

In some implementations, the system can be refactored to any modern computer programming language for inclusion in an information system in that an information system is an integrated set of components for collecting, storing, processing data.

In some implementations, the system may be incorporate directly into a computer program. In some implementations, the system may be incorporated into a computer program as a library or dependency. In some implementations, the system may be incorporated into a more complex information system where its methods are exposed in a fashion suitable to the client application(s) it serves (e.g., REST, GraphQL, or other suitable technology).

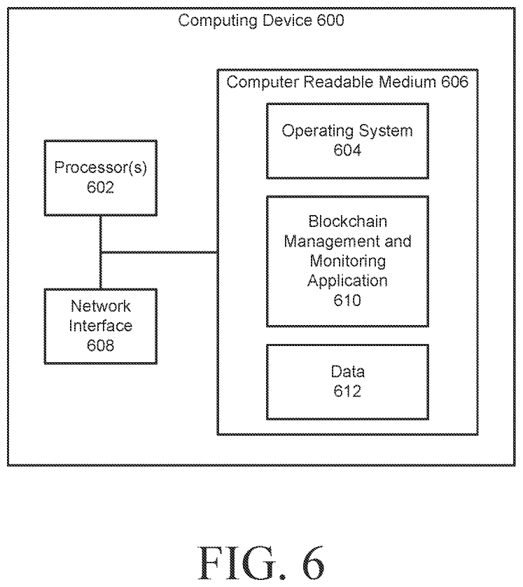

FIG. 6 is a diagram of an example computing device 600 in accordance with at least one implementation. The computing device 600 includes one or more processors 602, nontransitory computer readable medium 606 and network interface 608. The computer readable medium 606 can include an operating system 604, an application 610 for managing (e.g., queuing, batching, submission, and logging) and monitoring distributed blockchain operations and a data section 612 (e.g., for storing blockchain transaction information, blockchain account information such as balance, etc.).

In operation, the processor 602 may execute the application 610 stored in the computer readable medium 606. The application 610 can include software instructions that, when executed by the processor, cause the processor to perform operations for managing (e.g., queuing, batching, submission, and logging) and monitoring distributed blockchain operations in accordance with the present disclosure (e.g., performing associated functions described above and shown in FIGS. 3 and 4).

The application program 610 can operate in conjunction with the data section 612 and the operating system 604.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general-purpose computer, a special purpose computer, a microprocessor, a network server or switch, or the like.

It is, therefore, apparent that there is provided, in accordance with the various embodiments disclosed herein, methods, systems and computer readable media for managing (e.g., queuing, batching, submission, and logging) and monitoring distributed blockchain operations.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A method comprising:
receiving a transaction for a blockchain;
writing the transaction to a data store;
packaging and formatting the transaction according to a given blockchain network;
verifying that the transaction is structured as required by the given blockchain network;
submitting a transaction operation to the blockchain node using the API provided by the blockchain network node;
monitoring progression of the transaction to completion;
storing progression of the transaction; and
determining success or failure of the transaction.

2. The method of claim 1, wherein, when a blockchain node required to complete the transaction is unavailable, accepting into a queue the transaction ultimately intended for the blockchain node until the blockchain node returns to service ensuring no transactional activity sent by the client application is lost.

3. The method of claim 1, wherein a blockchain node required to complete a procedure initiated by the application is for the processing of cryptocurrency a spend transaction submitted to the API will fast fail and return an appropriate code to the calling client application.

4. The method of claim 1, wherein, when the application user has insufficient funds associated with their cryptocurrency account/address or the API determines that the balance associated with the cryptocurrency account/address less any pending and in process transactions managed and monitored is insufficient to complete the transaction, an indication of insufficient funds is returned.

5. The method of claim 1, further comprising maintaining a correct available balance is returned regardless of the processing state of the operation and transaction in the blockchain network or operational condition of the blockchain node.

6. The method of claim 1, wherein the blockchain node required to complete the procedure intended by the application is for the processing of cryptocurrency once any pending and in process transactions monitored by the system are completed, the available balance reported is equal to the actual balance of the blockchain account/address.

7. The method of claim 1, further comprising querying the blockchain node as desired by the application or on a regularly configured schedule and updating the recorded progress of the submitted transaction in its associated data store.

8. The method of claim 1, further comprising when several or many transactions are submitted, attempting to combine the individual transactions into a single transaction where the blockchain node supports a send many transaction or write many transaction.

9. A system comprising:
a processor coupled to a nontransitory computer readable medium having stored thereon software instructions that, when executed by the processor, cause the processor to perform operations including:
receiving a transaction for a blockchain;
writing the transaction to a data store;
packaging and formatting the transaction according to a given blockchain network;
verifying that the transaction is structured as required by the given blockchain network;
submitting a transaction operation to the blockchain node using the API provided by the blockchain network node;
monitoring progression of the transaction to completion;
storing progression of the transaction; and
determining success or failure of the transaction.

10. The system of claim 9, wherein, when a blockchain node required to complete the transaction is unavailable, accepting into a queue the transaction ultimately intended for the blockchain node until the blockchain node returns to service ensuring no transactional activity sent by the client application is lost.

11. The system of claim 9, wherein a blockchain node required to complete a procedure initiated by the application is for the processing of cryptocurrency a spend transaction submitted to the API will fast fail and return an appropriate code to the calling client application.

12. The system of claim 9, wherein, when the application user has insufficient funds associated with their cryptocurrency account/address or the API determines that the balance associated with the cryptocurrency account/address less any pending and in process transactions managed and monitored is insufficient to complete the transaction, an indication of insufficient funds is returned.

13. The system of claim 9, wherein the instructions further include maintaining a correct available balance is returned regardless of the processing state of the operation and transaction in the blockchain network or operational condition of the blockchain node.

14. The system of claim 9, wherein the blockchain node required to complete the procedure intended by the application is for the processing of cryptocurrency once any pending and in process transactions monitored by the system are completed, the available balance reported is equal to the actual balance of the blockchain account/address.

15. The system of claim 9, wherein the instructions further include querying the blockchain node as desired by the application or on a regularly configured schedule and updating the recorded progress of the submitted transaction in its associated data store.

16. The system of claim 9, wherein the instructions further include when several or many transactions are submitted, attempting to combine the individual transactions into a single transaction where the blockchain node supports a send many transaction or a write many transaction.

17. A non-transitory computer readable medium having stored thereon software instructions that, when executed by a processor, cause the processor to perform operations including:
receiving a transaction for a blockchain;
writing the transaction to a data store;
packaging and formatting the transaction according to a given blockchain network;
verifying that the transaction is structured as required by the given blockchain network;
submitting a transaction operation to the blockchain node using the API provided by the blockchain network node;
monitoring progression of the transaction to completion;
storing progression of the transaction; and
determining success or failure of the transaction.

18. The non-transitory computer readable medium of claim 17, wherein, when a blockchain node required to complete the transaction is unavailable, accepting into a queue the transaction ultimately intended for the blockchain node until the blockchain node returns to service ensuring no transactional activity sent by the client application is lost.

19. The non-transitory computer readable medium of claim 17, wherein a blockchain node required to complete a procedure initiated by the application is for the processing of cryptocurrency a spend transaction submitted to the API will fast fail and return an appropriate code to the calling client application.

20. The non-transitory computer readable medium of claim 17, wherein, when the application user has insufficient funds associated with their cryptocurrency account/address or the API determines that the balance associated with the cryptocurrency account/address less any pending and in process transactions managed and monitored is insufficient to complete the transaction, an indication of insufficient funds is returned.
